(19) United States
(12) Patent Application Publication
(10) Pub. No.: US 2009/0290015 A1
(43) Pub. Date: Nov. 26, 2009

(54) VEGETATION DETECTOR AND RELATED METHOD

(75) Inventor: Hajime BANNO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: IHI Corporation, Koto-ku (JP); IHI AEROSPACE CO., LTD., Koto-ku (JP)

(21) Appl. No.: 12/470,076

(22) Filed: May 21, 2009

(30) Foreign Application Priority Data
May 23, 2008 (JP) 2008-135713

(51) Int. Cl. H04N 7/18

(52) U.S. Cl. 348/61; 348/E07.085

(57) ABSTRACT

A vegetation detector 10 includes a first imaging section 11, a second imaging section 12, a reflectance ratio calculating section 13, a determining section 14 and a recording section 15. The first imaging section 11 images light with a predetermined wavelength band of near infrared light. The second imaging section 12 images light with a water absorption wavelength band in short wave infrared light. The reflectance ratio calculating section 13 calculates a ratio of the reflectance of light with the near infrared light wavelength band to the light reflectance of light with the water absorption wavelength band as a reflectance ratio. The determining section 14 determines whether observed subjects are vegetations or not by comparing the reflectance ratio calculated by the reflectance ratio calculating section 13 with a threshold value recorded in the recording section 15.

### BACKGROUND OF THE INVENTION

1. Field of the Invention

The present invention relates to a device and method to detect a distribution of vegetations.

2. Description of Related Art

Patent Citation 1 (Japanese Patent Application Laid-Open No. 2002-117402) discloses a method to discriminate between vegetations and other subjects by distinguishing detailed colors of green sections by means of visible light.

Patent Citation 2 (Japanese Patent Application Laid-Open No. 2007-018387) discloses a method to discriminate between vegetations and other subjects by means of NDVI (Normalized Differenced Vegetation Index) commonly used in satellite remote sensing based on the reflectance of two color lights, near infrared (NIR) light (wavelength band: 800 to 1200 nm) and visible red (VISR) light (wavelength band: 600 to 700 nm).

### SUMMARY OF THE INVENTION

With regard to an image in which bright spots and dark (shadow) spots are present, such as an image of sunlight filtering through trees, there is not much of a gradation difference between pixels with low luminance values such as pixels framing the shadow parts. In those pixels output values from a camera (values in RBG space) become similar. While, with regard to the luminance (reflectance) of visible light, there is a little difference in the reflectances (or color values) of red, blue and green lights. Regarding low shrubs, for instance, the reflectance of red light is 18% and the reflectance of green light is approximately 12%. Thus, in the method of Patent Citation 1 discrimination errors between vegetations and the other subjects in an image of sunlight filtering through trees are easily caused since the pixels of shadow parts in the image are affected by noise.

Also, large field constructions are made from some typical materials such as sand, soil, rock, cement, asphalt, plastic. Table 1 shows the reflectance of near infrared light, the reflectance of visible red light and the reflectance ratio thereof under daylight. As shown in the table, specifically the reflectance ratio of light from blue-colored plastics is close to that from grass (100 mm height). This is not a problem since it is not necessary to distinguish vegetations from such materials in air photographs or satellite photographs. However, the constructions made from the blue-colored plastics are accidentally detected as vegetations by means of the method described in Patent Citation 2.

TABLE 1

| | NIR | SWIR | Reflectance |
|---|---|---|---|
| Objects | Reflectance | Reflectance | Ratio |
| Broadleaf Tree | 38.2% | 4.2% | 9.1 |
| Conifer | 26.4% | 5.6% | 4.7 |
| Low Shrub | 39.7% | 4.0% | 9.9 |
| Grass (100 mm height) | 33.7% | 10.4% | 3.2 |
| Plastic (Blue) | 62.9% | 17.1% | 3.7 |
| Gravel | 16.5% | 14.3% | 1.2 |
| Soil | 12.9% | 7.8% | 1.7 |
| Sand | 24.5% | 21.0% | 1.2 |
| Asphalt | 12.3% | 8.1% | 1.5 |
| Cement Floor | 18.4% | 16.9% | 1.1 |

In addition, when a vegetation detecting operation is performed at night by means of the methods of Patent Citations 1 and 2, a floodlight using a light source of strong visible light such as a searchlight is needed. It causes the operators to be dazzled by the strong light or causes the location of security guards on duty to be clear so as to let suspicious people know the location of the guards.

In order to solve the above-mentioned issues, the present invention has a purpose of providing a vegetation detector and a related method capable of (1) preventing discrimination errors between vegetations and other subjects even in a situation where bright spots and dark spots are present, such as in a section with sunlight filtering through trees, (2) preventing constructions constructed of blue-colored plastics from accidentally being detected as vegetations, and (3) operating detection of vegetations at night without a floodlight using a light source of strong visible light such as a searchlight.

According to a first aspect of the present invention, there is provided a vegetation detector including: (1) a first imaging section that includes a first optical filter selectively transmitting light with a near infrared wavelength band; (2) a second imaging section that includes a second optical filter selectively transmitting light with a short wave infrared wavelength band; (3) a reflectance ratio calculating section that calculates a ratio of a reflectance calculated based on observation data of light from subjects obtained by the first imaging section to a reflectance calculated based on observation data of light from the subjects obtained by the second imaging section as a reflectance ratio; (4) and a determining section that determines whether the subjects are vegetations or not by comparing the reflectance ratio with a predetermined threshold value.

According to a second aspect of the present invention, there is provided a method of detecting vegetation including: (1) calculating a ratio of a reflectance calculated based on observation data of light from subjects obtained by a first imaging section including a first optical filter selectively transmitting light with a near infrared wavelength band to a reflectance calculated based on observation data of light from the subjects obtained by a second imaging section including a second optical filter selectively transmitting light with a short wave infrared wavelength band as a reflectance ratio; and (2) determining whether the subjects are vegetations or not by comparing the reflectance ratio with a predetermined threshold value.

### BRIEF DESCRIPTION OF DRAWINGS

FIG. 1 shows a whole structural view of a vegetation detector according to an embodiment of the present invention.

FIG. 2 shows an example of a camera with a plurality of plates capable of using for the vegetation detector shown in FIG. 1.

FIG. 3 shows an example of a plurality of cameras capable of using for the vegetation detector shown in FIG. 1.

FIG. 4 shows an overall procedure of vegetation detecting operation in the vegetation detector shown in FIG. 1.

FIG. 5 shows a procedure of coordinate transforming operator when using a plurality of the cameras shown in FIG. 3.

FIG. 6 illustrates a coordinate transformation between a plurality of the cameras shown in FIG. 3.

FIG. 7 shows the reflectance of each wavelength of light from a broadleaf tree.

FIG. 8 shows relationships between actual reflectance and reflectance ratio.

### DETAILED DESCRIPTION OF PREFERRED EMBODIMENT

There will be described below a preferred embodiment of the present invention with reference to the drawings. Note that in the figures common elements are indicated with the same reference numerals and the repetitive explanations are omitted.

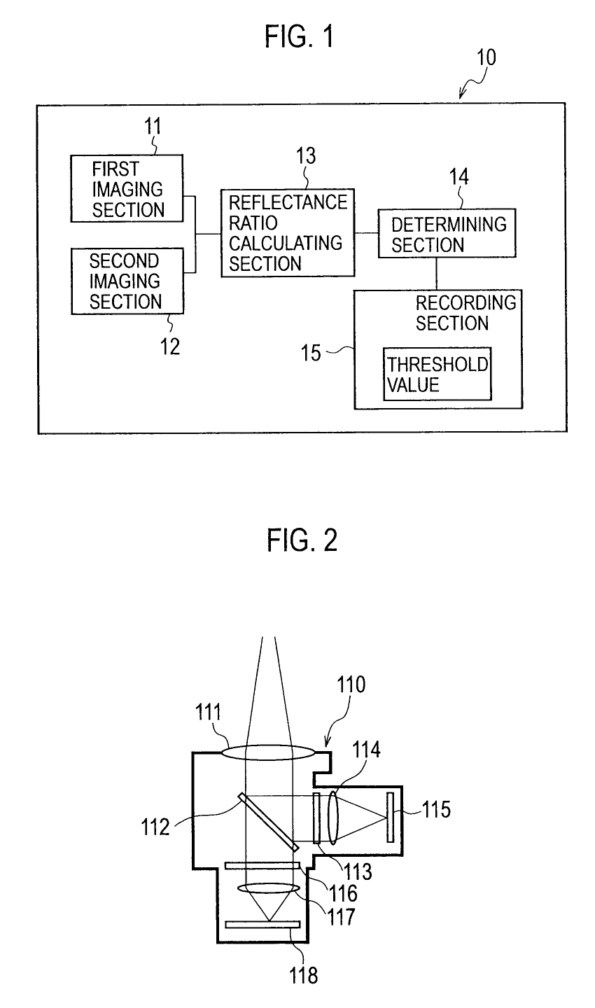

FIG. 1 is a whole structural view of a vegetation detector according to an embodiment of the present invention. As shown in the figure, a vegetation detector 10 includes a first imaging section 11, a second imaging section 12, a reflectance ratio calculating section 13, a determining section 14 and a recording section 15.

The first imaging section 11 images light with a predetermined wavelength band in a wavelength band (800 nm to 1300 nm) of near infrared (NIR) light. The second imaging section 12 images light with a water absorption wavelength band (1450 nm±50 nm, or 1940 nm±100 nm) in a wavelength band of short wave infrared (SWIR) light. The first imaging section 11 and the second imaging section 12 can simultaneously obtain exposure times and gains at taking images of a subject. The reflectance ratio calculating section 13 calculates the ratio of the reflectance of light with the near infrared light wavelength band to the reflectance of light with the water absorption wavelength band by means of the later-described method. The determining section 14 determines whether the subject is a vegetation or not by comparing the reflectance ratio calculated by the reflectance ratio calculating section 13 with a threshold value recorded in the recording section 15.

FIG. 4 shows an overall procedure of vegetation detecting operation in the vegetation detector shown in FIG. 1. As shown in the figure, the procedure includes processes of (1) calculating the ratio (reflectance ratio) of the light reflectance calculated based on observation data of a subject with regard to light with a near infrared wavelength band obtained by the first imaging section to light reflectance calculated based on observation data of the subject with regard to light with a water absorption wavelength band obtained by the second imaging section (Step S11), and (2) determining whether the subject is a vegetation or not by comparing the reflectance ratio with a predetermined threshold value (Step S12).

### [Imaging Section]

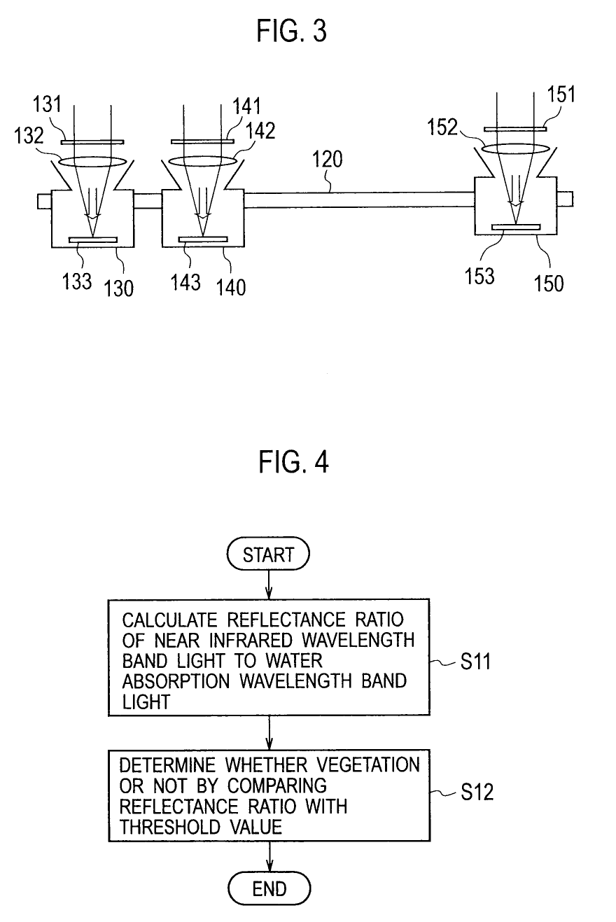

FIG. 2 shows an example of a camera with a plurality of plates capable of using for the vegetation detector shown in FIG. 1. FIG. 3 shows an example of a plurality of cameras capable of using for the vegetation detector shown in FIG. 1. As shown in FIG. 2, the present embodiment may have a single camera including a half mirror and the like so as to take an image by separating incident light into two lights with different wavelength (or frequency) bands by the half mirror and the like. As shown in FIG. 3, the present embodiment may also have a plurality of cameras, of which each images incident lights with different wavelength bands facing in the same direction.

As shown in FIG. 2, a plural plate camera 110 includes a lens 11, a half mirror 112, a water absorption wavelength band light transmission filter 113, a lens 114, an InSb semiconductor light receiving element 115, a near infrared light transmission filter 116, a lens 117 and a CCD (charge-coupled device) light receiving element 118. The half mirror (or dichroic mirror) 112 reflects light with a specific wavelength band. The near infrared light transmission filter 116, the lens 117 and the CCD light receiving element 118 correspond to the first imaging section, and the water absorption wavelength band light transmission filter 113, the lens 114 and the InSb semiconductor light receiving element 115 correspond to the second imaging section.

As shown in FIG. 3, a first near infrared light camera 130, a water absorption wavelength band light (short wave infrared light) camera 140 and a second near infrared light camera 150 are fixed on a fixture 120. The first near infrared light camera 130 includes a near infrared light transmission filter 131, a lens 132 and a CCD light receiving element 133. The water absorption wavelength band light camera 140 includes a water absorption wavelength band light transmission filter 141, a lens 142 and an InSb semiconductor light receiving element 143. The second near infrared light camera 150 includes a near infrared light transmission filter 151, a lens 152 and a CCD light receiving element 153. The first near infrared light camera 130 and the second near infrared light camera 150 correspond to the first imaging section, and the water absorption wavelength band light camera 140 corresponds to the second imaging section.

The near infrared light transmission filters 116, 131 and 151 only (selectively) transmit light with a predetermined wavelength band in the near infrared light band. The water absorption wavelength band light transmission filters 113 and 141 only (selectively) transmit light with a wavelength band that water absorbs.

As for the near infrared light transmission filters 116, 131 and 151, a filter, such as a long pass filter that only transmits the light with a wavelength of 800 nm or more, or such as a band pass filter that transmits light with a wavelength of 800 nm or more and of which a transmission wavelength width is 100 nm or more, is preferably used. The former filter is used when the filter only restricts the lower limit of the transmission range since the upper limit of the light receiving wavelength of the CCD camera is approximately between 900 nm to 1100 nm. While, the latter filter is used in order to transmit light with a wavelength of 800 nm or more and make the transmission wavelength width wide as much as possible since the light receiving energy becomes small and the signal-to-noise ratio becomes worse if the transmission wavelength width is narrow.

As for the water absorption wavelength band light transmission filters 113 and 141, a filter, such as a band pass filter having a transmission central wavelength of 1450 nm and a transmission wavelength width of 80 nm, is used. According to vegetation observation results, it has been clarified that: the central wavelength of light that water absorbs is 1450 nm; the absorption rate of light with a wavelength of 1400 nm to 1500 nm is high; and the absorption rate of light with a wavelength of 1350 nm or less and 1550 nm or more is low. Therefore, as a water absorption wavelength band light transmission filter, it is preferably used the band pass filter fulfilling the conditions that: the lower limit of the transmission wavelength is more than 1350 nm; the upper limit of the transmission wavelength is less than 1550 nm; and the transmission wavelength width is 50 nm or more.

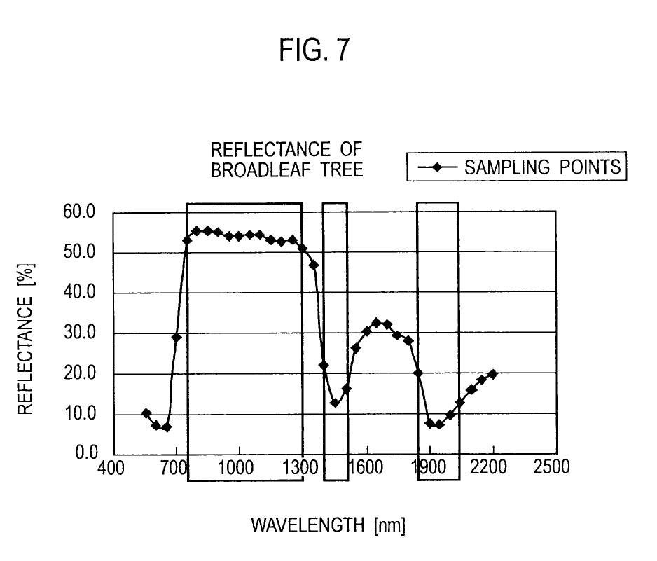

FIG. 7 shows the reflectance of each wavelength of light from a broadleaf tree. Since it is assumed that to compare between wavelengths in the three wavelength bands surrounded by squares in the figure is effective to observe characteristics of the broadleaf tree, these wavelength hands are used for the present embodiment. In the figure, the two selected regions from the right are typical wavelength bands with low reflectance (that means high light absorption) and the left selected region is a typical wavelength band with high reflectance (that means low light absorption).

By selecting two wavelengths in order to make the reflectance ratio large, it is possible to detect vegetations in observation points with high luminance contrast. Therefore the two different wavelengths are preferably selected so as to make the reflectance ratio larger. However it is not sufficient to image only light with wavelengths at peaks with high reflectance and at peaks with low reflectance. When the wavelength width of light to be imaged is narrow, which means only peaks are taken, the received light energy becomes small and the signal-to-noise ratio becomes worse. Thus it is necessary to make the wavelength width of receiving light wide and to select wavelengths of which the reflectance ratio of light to be imaged is sufficiently large (or sufficiently small). The selected regions in the figure satisfy the conditions and therefore the wavelength bands of receiving light are preferably determined in view of camera characteristics and filter characteristics within the regions. Note that the wavelengths of the both ends in each selected region are determined according to the following determination criteria: (1) the both ends are defined in boundaries that reflectance values are changed; and (2) sampling points within the average of a high peak and a low peak before and after changing (right and left direction in the figure) are the limit values of the both ends.

### [Gain Control]

Gains are controlled to be able to pick up images by each camera with appropriate luminance at imaging. Therefore it may be appropriately used techniques to enable an auto gain control that is usually equipped with cameras, or to control exposure time so that almost the entire subject (except small shining parts such as a spotlight-like illuminant) corresponds to the imaging range.

### [Coordinate Transformation]

A same observation point of a subject is indicated as different coordinate values (pixel coordinate values) in coordinate systems set in lenses, respectively, since each lens has a different field of view. Therefore it is necessary to perform coordinate transformation between the coordinate systems to relate a coordinate value representing the same observation point in one coordinate system to a coordinate value representing the same observation point in the other coordinate system.

### [Coordinate Transformation—Use of Plural Plate Camera]

When the plural plate camera 110 shown in FIG. 2 is used, the focal distances of a light path through the lens 114 (a lens group of the lens 111 and the lens 114) and a light path through 117 (a lens group of the lens 111 and the lens 117) are different, and the pixel intervals on the InSb semiconductor light receiving element 115 and on the CCD light receiving element 118 are different. Thus in general the coordinate values of pixels representing a same observation point of a subject become different between the coordinate systems of the CCD light receiving element 118 and the InSb semiconductor light receiving element 115.

Therefore the coordinate value of each pixel in the coordinate system of the CCD light receiving element 118 is transformed into the corresponding coordinate value in the coordinate system of the InSb semiconductor light receiving element 115 by using

$$\begin{matrix}{{P}^{->}}_{S W I R} = {A}_{S W I R} {RA}_{N I R}^{- 1} {{P}^{->}}_{N I R} \\ where & ( 1 \text{-} 1 ) \\ {{P}^{->}}_{N I R} = ( \begin{matrix}{x}_{N I R} \\ {y}_{N I R} \\ 1\end{matrix} ) , \\ {{P}^{->}}_{S W I R} = ( \begin{matrix}{x}_{S W I R} \\ {y}_{S W I R} \\ 1\end{matrix} ) , \\ {A}_{N I R} = ( \begin{matrix}{fx}_{N I R} & 0 & {cx}_{N I R} \\ 0 & {fy}_{N I R} & {cy}_{N I R} \\ 0 & 0 & 1\end{matrix} ) , \\ {A}_{S W I R} = ( \begin{matrix}{fx}_{S W I R} & 0 & {cx}_{S W I R} \\ 0 & {fy}_{S W I R} & {cy}_{S W I R} \\ 0 & 0 & 1\end{matrix} ) . & ( 1 \text{-} 2 )\end{matrix}$$

Here (x_{NIR}, y_{NIR}) is the coordinate value of each pixel on the light receiving surface of the CCD light receiving element 118; (x_{SWIR}, y_{SWIR}) is the coordinate value of each pixel on the light receiving surface of the InSb semiconductor light receiving element 115; fx_{NIR} and fy_{NIR} are the focal distances of the lens 117 of the CCD light receiving element 118 in the x-axis and y-axis directions; fx_{SWIR} and fy_{SWIR} are the focal distances of the lens 114 of the InSb semiconductor light receiving element 115 in the x-axis and y-axis directions; (cx_{NIR}, cy_{NIR}) is the coordinate value of the center of the light axis on the CCD light receiving element 118; (cx_{SWIR}, cy_{SWIR}) is the coordinate value of the center of the light axis on the InSb semiconductor light receiving element 115; and R is a 3×3 rotation matrix from the coordinate system of the CCD light receiving element 118 to the coordinate system of the InSb semiconductor light receiving element 115. Note that R is the unit matrix I when each light receiving surface is accurately placed perpendicular to the light axis.

Since this coordinate transformation enables to match the coordinate value of the pixel representing each observation point of the subject in the CCD light receiving element 118 with the coordinate value of the pixel representing each observation point of the subject in the InSb semiconductor light receiving element 115, it is possible to compare observation data between pixels corresponding in the coordinate systems.

### [Coordinate Transformation—Use of Plurality of Cameras]

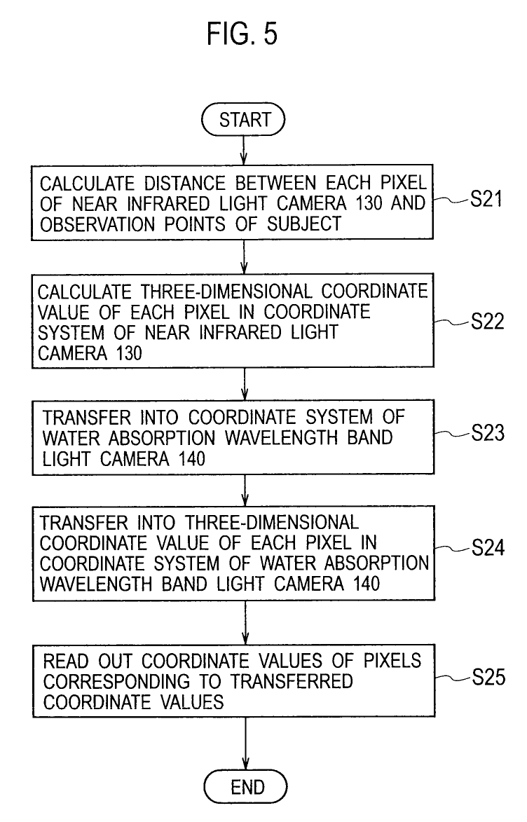

When a plurality of cameras are used as shown in FIG. 3, the pixel locations of the cameras for different wavelength bands are obtained so as to match the coordinate value of a pixel representing a same observation point of a subject in one camera to the coordinate value of a pixel representing the same observation point of the subject in the other camera, as described below. FIG. 5 shows a procedure of coordinate transforming operation when using a plurality of the cameras (the first near infrared light camera 130, the water absorption wavelength band light camera 140 and the second near infrared light camera 150) shown in FIG. 3. As shown in the figure, in Step S21 a distance d between each pixel of the first near infrared light camera 130 and the observation point of the subject is obtained. In Step S22 a three-dimensional coordinate value of each pixel of the first near infrared light camera 130 in a coordinate system of the first near infrared light camera 130 are obtained. In Step S23 the coordinate system of the first near infrared light camera 130 is transformed into a coordinate system of the water absorption wavelength band light camera 140. In Step S24 the three-dimensional coordinate value of each pixel in the coordinate system of the first near infrared light camera 130 is transformed into a coordinate value in the coordinate system of the water absorption wavelength band light camera 140. In Step S25 the coordinate value of each pixel corresponding to the transformed three-dimensional coordinate value are read out.

### [S21]

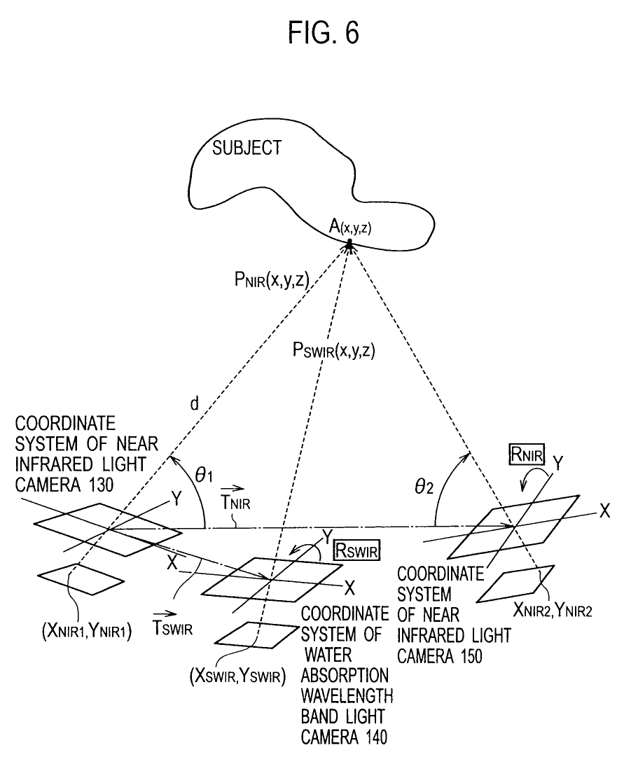

FIG. 6 is an explanatory view of the coordinate transformation between pixels of the first near infrared light camera 130, the water absorption wavelength band light camera 140 and the second near infrared light camera 150. As shown in the figure, R_{NIR} is a rotation matrix representing a coordinate system rotation from a coordinate system of the first near infrared light camera 130 to a coordinate system of the second near infrared light camera 150. \vec{T}_{NIR} is a translation vector representing a translation from the coordinate center of the first near infrared light camera 130 to the coordinate center of the second near infrared light camera 150.

When the coordinate (X_{NIR1}, Y_{NIR1}) of an observation point of a subject on a light receiving surface of the first near infrared light camera 130 and the corresponding coordinate (X_{NIR2}, Y_{NIR2}) of the observation point of the subject on a light receiving surface of the second near infrared light camera 150 are discovered, it is possible to obtain θ₁, θ₂, |\vec{T}_{NIR}| by accurately measuring R_{NIR} and \vec{T}_{NIR} in advance. Moreover, it is possible to obtain the distance d between each pixel of the first near infrared light camera 130 and the observation point of the subject by means of triangulation method using these measured values.

θ₁, θ₂, |\vec{T}_{NIR}| can be obtained by (S21-1) to (S21-3) as described below.

(S21-1) A position vector \vec{P}₂₋₂ representing an observation point of the subject in the coordinate system of the second near infrared light camera 150 can be described as

$${P}_{2 \text{-} 2} = ( \begin{matrix}{x}_{N I R 2} \\ {y}_{N I R 2} \\ 1\end{matrix} ) \qquad ( 2 )$$

by use of the coordinate (x_{NIR2}, y_{NIR2}) of the observation point on the light receiving surface of the second near infrared light camera 150. In this case, θ₂ is calculated as

$${θ}_{2} = {cos}^{- 1} ( \frac{- {{T}^{->}}_{N I R} \cdot {{P}^{->}}_{2 \text{-} 2}}{\vert - {{T}^{->}}_{N I R} \vert \cdot \vert {{P}^{->}}_{2 \text{-} 2} \vert} ) \qquad ( 3 )$$

### by use of P₂₋₂.

(S21-2) A position vector \vec{P}₁₋₂ representing the observation point in the coordinate system of the second near infrared light camera 150 observed from the first near infrared light camera 130 can be obtained, by use of

\vec{P}₁₋₂=A₂R_{NIR}A₁⁻¹\vec{P}₁₋₁, (4)

by transforming a position vector

$${{P}^{->}}_{1 \text{-} 1} = ( \begin{matrix}{x}_{N I R 1} \\ {y}_{N I R 1} \\ 1\end{matrix} ) \qquad ( 5 )$$

representing the observation point in the coordinate system of the first near infrared light camera 130, into the coordinate system of the second near infrared light camera 150. Here A₁ and A₂ are 3×3 matrices described as

$${A}_{1} = ( \begin{matrix}{fx}_{1} & 0 & {cx}_{1} \\ 0 & {fy}_{1} & {cy}_{1} \\ 0 & 0 & 1\end{matrix} ) , \\ {A}_{2} = ( \begin{matrix}{fx}_{2} & 0 & {cx}_{2} \\ 0 & {fy}_{2} & {cy}_{2} \\ 0 & 0 & 1\end{matrix} ) \qquad ( 6 )$$

similar to formula (1), respectively, where fx₁ and fy₁ are the focal distances of the lens 132 of the first near infrared light camera 130 in the x-axis and y-axis directions; fx₂ and fy₂ are the focal distances of the lens 152 of the second near infrared light camera 150 in the x-axis and y-axis directions; (cx₁, cy₁) is the coordinate value of the center of the light axis on the first near infrared light camera 130; (cx₂, cy₂) is the coordinate value of the center of the light axis on the second near infrared light camera 150. Here θ₁ is calculated as

$${θ}_{1} = {cos}^{- 1} ( \frac{{{T}^{->}}_{N I R} \cdot {{P}^{->}}_{1 \text{-} 2}}{\vert {{T}^{->}}_{N I R} \vert \cdot \vert {{P}^{->}}_{2 \text{-} 2} \vert} ) \qquad ( 7 )$$

by use of \vec{P}₁₋₂.

(S21-3) A distance |\vec{T}_{NIR}| between the observing points of the second near infrared light camera 150 and the first near infrared light camera 130 is calculated as an absolute value of \vec{T}_{NIR}.

The above-mentioned corresponding points (X_{NIR1}, Y_{NIR1}) and (X_{NIR2}, Y_{NIR2}) can be obtained by block matching between two images or by optical flow. Alternatively, it is possible to use a method of obtaining a matrix

F=TₓR_{NIR} (8)

from the rotation matrix R_{NIR} and a matrix

$${T}_{x} = ( \begin{matrix}0 & - {t}_{3} & {t}_{2} \\ {t}_{3} & 0 & - {t}_{1} \\ - {t}_{2} & {t}_{1} & 0\end{matrix} ) \qquad ( 9 )$$

rearranging the elements t₁, t₂ and t₃ of the translation vector \vec{T}_{NIR}, so as to detect common pixels by searching on a straight line (epipolar line) to fulfill constraint conditions:

$$\begin{matrix}{{P}^{->}}_{N I R 1}^{t} \cdot F \cdot {{P}^{->}}_{N I R 2} = 0 \\ where & ( 10 \text{-} 1 ) \\ {{P}^{->}}_{N I R 1} = ( \begin{matrix}{X}_{N I R 1} \\ {Y}_{N I R 1} \\ 1\end{matrix} ) , \\ {{P}^{->}}_{N I R 2} = ( \begin{matrix}{X}_{N I R 2} \\ {Y}_{N I R 2} \\ 1\end{matrix} ) . & ( 10 \text{-} 2 )\end{matrix}$$

### [S22]

The distance d is calculated as

$$d = \vert {{T}^{->}}_{N I R} \vert \times \frac{sin {θ}_{2}}{sin ( 2 π - {θ}_{1} - {θ}_{2} )} \qquad ( 11 )$$

by means of sine theorem. Thus, the three-dimensional coordinate value of each pixel in the coordinate system of the first near infrared light camera 130 can be calculated as

\vec{P}_{NIR}=\vec{P}_{NIR1}·d. (12)

The distance has been measured by a stereo camera in this case. However it is possible to measure the distance by use of a three-dimensional laser range finder that makes a positional relationship clear or the other alternative methods. In addition, when the three-dimensional geometry of a subject is almost determined by maps or rules (e.g. almost no undulation), the three-dimensional location can be determined based on the maps or rules so as to transform between the corresponding points.

### [S23]

The coordinate transformation from the coordinate system of the first near infrared light camera 130 into the coordinate system of the water absorption wavelength band light camera 140 can be calculated as

\vec{P}_{SWIR}=R_{SWIR}\vec{P}_{NIR}+\vec{T}_{SWIR} (13)

where \vec{T}_{SWIR} is a translation vector representing a translation from the coordinate center of the first near infrared light camera 130 to the coordinate center of the water absorption wavelength band light camera 140; and R_{SWIR} is a rotation matrix representing a rotation from the coordinate system of the first near infrared light camera 130 to the coordinate system of the water absorption wavelength band light camera 140.

### [S24]

From the three-dimensional coordinate values in the coordinate system of the first near infrared light camera 130, the three-dimensional location \vec{P}_{SWIR} of each corresponding pixel in the coordinate system of the water absorption wavelength band light camera 140 can be calculated as

$${{P}^{->}}_{S W I R} = {A}_{S W I R}^{- 1} {n}^{->} \cdot ( \begin{matrix}{X}_{S W I R} \\ {Y}_{S W I R} \\ 1\end{matrix} ) \qquad ( 14 )$$

where A_{SWIR} is a 3×3 matrix represented by

$${A}_{S W I R} = ( \begin{matrix}{fx}_{S W I R} & 0 & {cx}_{S W I R} \\ 0 & {fy}_{S W I R} & {cy}_{S W I R} \\ 0 & 0 & 1\end{matrix} ) \qquad ( 15 )$$

similar to formula (1), where fx_{SWIR} and fy_{SWIR} are the focal distances of the lens 142 of the water absorption wavelength band light camera 140 in the x-axis and y-axis directions; (cx_{SWIR}, cy_{SWIR}) is the coordinate value of the center of the light axis on the water absorption wavelength band light camera 140. Also, \vec{n} is a normal vector.

### [S25]

The coordinate values transformed as described above cannot always become integral numbers in general. Therefore the coordinate value of a pixel is estimated from the coordinate values of the peripheral pixels by means of bilinear interpolation method. Thus, since it is possible to match the coordinate value of each observation point of the subject in the first near infrared light camera 130 with the coordinate value of each observation point of the subject in the water absorption wavelength band light camera 140 after the coordinate transformation, it is possible to compare observation data between pixels corresponding in the coordinate systems.

### [Reflectance Ratio]

With regard to the use of the plural plate camera shown in FIG. 2 and the plural cameras shown in FIG. 3 in either case, the ratio (reflectance ratio)

$${Rate}_{Ref} ( x , y , z \text{:} t ) = \frac{{R}_{N I R} ( x , y , z )}{{R}_{S W I R} ( x , y , z )} \qquad ( 16 )$$

of the reflectance R_{NIR}(x, y, z:t) of light with the near infrared wavelength band to the reflectance R_{SWIR}(x, y, z:t) of light with the water absorption wavelength band in each observation point of the subject (three-dimensional coordinate (x, y, z)) at a time t is obtained by the following method after each pixel corresponding to each observation point of the subject is detected in the near infrared light camera and the water absorption wavelength band light camera, respectively. This reflectance ratio is proportional to the ratio of the received light amount

$${I}_{N I R} ( X , Y \text{:} t ) = \frac{{V}_{N I R} ( X , Y \text{:} t )}{{E}_{N I R} ( t ) \cdot {K}_{N I R} ( t )} \qquad ( 17 )$$

per hour at the time t in each pixel of the near infrared light camera (coordinate (X, Y) on the light receiving surface) to the received light amount

$${I}_{S W I R} ( X , Y \text{:} t ) = \frac{{V}_{S W I R} ( X , Y \text{:} t )}{{E}_{S W I R} ( t ) \cdot {K}_{S W I R} ( t )} \qquad ( 18 )$$

per hour at the time t in each pixel of the water absorption wavelength band light camera (coordinate (X, Y) on the light receiving surface). Here V_{NIR} (X, Y:t) and V_{SWIS}(X, Y:t) are coordinate values of the pixels represented as coordinates (X, Y) on the light receiving surfaces in the near infrared light camera and the water absorption wavelength band light camera at the time of t; E_{λ}(t) is an exposure time at the time t; and K_{λ}(t) is an imaging gain at the time of t.

In other words, the ratio of the reflectance R_{NIR}(x, y, z:t) of the near infrared light to the reflectance R_{SWIR}(x, y, z:t) of the water absorption wavelength band light in an observation point (x, y, z) of the subject at the time t can be represented as

$$\begin{matrix}\begin{matrix}{Rate}_{Ref} ( x , y , z \text{:} t ) = \frac{{R}_{N I R} ( x , y , z \text{:} t )}{{R}_{S W I R} ( x , y , z \text{:} t )} \\ = {C}_{Ref} \times \frac{{I}_{N I R} ( X , Y \text{:} t )}{{I}_{S W I R} ( X , Y \text{:} t )} \\ = {C}_{Ref} \times \\ \frac{{V}_{N I R} ( X , Y \text{:} t ) / ( {E}_{N I R} ( t ) \cdot {K}_{N I R} ( t ) )}{{V}_{S W I R} ( X , Y \text{:} t ) / ( {E}_{S W I R} ( t ) \cdot {K}_{S W I R} ( t ) )}\end{matrix} & ( 19 )\end{matrix}$$

in the corresponding pixels of the near infrared light camera and the water absorption wavelength band light camera (both coordinates on the light receiving surfaces are (X, Y)). Here C_{Ref} is a reflectance ratio at calibration (t=t₀) and is calculated as

$$\begin{matrix}\begin{matrix}{C}_{Ref} = \frac{{R}_{N I R}^{Ref} ( x , y , z \text{:} {t}_{0} )}{{R}_{S W I R}^{Ref} ( x , y , z \text{:} {t}_{0} )} \cdot \\ \frac{{V}_{N I R} ( X , Y \text{:} {t}_{0} ) / ( {E}_{N I R} ( {t}_{0} ) \cdot {K}_{N I R} ( {t}_{0} ) )}{{V}_{S W I R} ( X , Y \text{:} {t}_{0} ) / ( {E}_{S W I R} ( {t}_{0} ) \cdot {K}_{S W I R} ( {t}_{0} ) )} \\ = \frac{{R}_{N I R}^{Ref} ( x , y , z \text{:} {t}_{0} )}{{R}_{S W I R}^{Ref} ( x , y , z \text{:} {t}_{0} )} \cdot \\ \frac{{I}_{N I R} ( X , Y \text{:} {t}_{0} )}{{I}_{S W I R} ( X , Y \text{:} {t}_{0} )} .\end{matrix} & ( 20 )\end{matrix}$$

C_{Ref} includes factors such as the light receiving sensitivity Q_{NIR} of the near infrared light camera at the time of t and the light receiving sensitivity Q_{SWIR} of the water absorption wavelength band light camera at the time t. In this case, V_{NIR}(X, Y:t₀) and V_{SWIR}(X, Y:t₀) represent the pixel values of a know object (subject for calibration such as a plate for reference) having the known reflectances of the near infrared light and the water absorption wavelength band light. R^{Ref}_{NIR}(x, y, z:t₀) and R^{Ref}_{SWIR}(x, y, z:t₀) represent known reflectances in the subject for calibration of the near infrared light and the water absorption wavelength band light, respectively.

It is possible to maintain calculating the accurate reflectance ratio when the light source is the same even imaging conditions are different from the near infrared light camera and the water absorption wavelength band light camera. When the ratio of the spectral amount of light from the light source alters, calibration may be constantly performed so as to obtain an image of the subject for calibration on the edges of the image any time. As for the subject for calibration, a standard reflector, of which the reflectance change in every kind of light from visible light to short wavelength infrared light is within 5%, is employed.

By comparing the reflectance ratio for each pixel calculated as described above with a predetermined threshold value, the vegetation detection that determines subjects with pixels having the reflectance more than a predetermined threshold value as vegetation leaves is executed. Preferably, the threshold value of the reflectance ratio is given according to weather conditions. For instance, the threshold value between 2.0 to 3.0 is used in fine weather and the threshold value between 2.5 to 3.0 is used in rainy weather. Alternatively, the threshold value of the reflectance ratio may be set at a common value between 2.5 to 3.0 in fine and rainy weather.

The basis for these threshold values is shown in Tables 2 and 3. Tables 2 and 3 show the observation results of the reflectances of the near infrared light and the water absorption wavelength band light, and reflectance ratios thereof in fine weather (dried condition) and in rainy weather (wet condition), respectively. In view of the reflectance ratios of the near infrared light and the water absorption wavelength band light obtained by the tests, it is apparent that the reflectance ratios of the vegetation leaves result in 4.0 or more and the reflectance ratios of the other subjects result in 2.5 or less in rainy weather (Table 3), and the reflectance ratios of the vegetation leaves result in 3.0 or more and the reflectance ratios of the other subjects result in 2.0 or less in fine weather (Table 2), as shown in Tables.

TABLE 2

| | | NIR | SWIR | Reflectance |
|---|---|---|---|---|
| Objects | Conditions | Reflectance | Reflectance | Ratio |
| Low | Frontal Image | 38.3% | 12.7% | 3.0 |
| Shrub | (Backlight) | | | |
| (Azalea) | | | | |
| Low | Frontal Image | 37.0% | 10.6% | 3.5 |
| Shrub | (Coaxial) | | | |
| (Azalea) | | | | |
| Grass | Image from above | 44.7% | 9.2% | 4.9 |
| (100 mm | (Backlight) | | | |
| height) | | | | |
| Grass | Image from above | 30.3% | 6.6% | 4.6 |
| (100 mm | (Coaxial) | | | |
| height) | | | | |
| Flagstone | Image from above | 13.2% | 13.4% | 1.0 |
| (Granite) | (Backlight) | | | |
| Flagstone | Image from above | 13.4% | 13.1% | 1.0 |
| (Granite) | (Coaxial) | | | |
| Plastic | Frontal Image | 64.0% | 42.1% | 1.5 |
| (Blue) | (Backlight) | | | |
| Plastic | Frontal Image | 63.5% | 32.7% | 1.9 |
| (Blue) | (Coaxial) | | | |

TABLE 3

| | | NIR | SWIR | Reflectance |
|---|---|---|---|---|
| Objects | Conditions | Reflectance | Reflectance | Ratio |
| Low | Frontal Image | 36.3% | 8.2% | 4.4 |
| Shrub | (Backlight) | | | |
| (Azalea) | | | | |
| Low | Frontal Image | 33.7% | 6.9% | 4.9 |
| Shrub | (Coaxial) | | | |
| (Azalea) | | | | |
| Grass | Image from above | 37.6% | 8.8% | 4.3 |
| (100 mm | (Backlight) | | | |
| height) | | | | |
| Grass | Image from above | 29.9% | 6.0% | 5.0 |
| (100 mm | (Coaxial) | | | |
| height) | | | | |
| Flagstone | Image from above | 5.8% | 3.8% | 1.5 |
| (Granite) | (Backlight) | | | |
| Flagstone | Image from above | 6.9% | 3.1% | 2.2 |
| (Granite) | (Coaxial) | | | |
| Plastic | Frontal Image | 60.6% | 41.7% | 1.5 |
| (Blue) | (Backlight) | | | |
| Plastic | Frontal Image | 60.8% | 32.1% | 1.9 |
| (Blue) | (Coaxial) | | | |

When a same threshold value is used in both fine and rainy weather, a value between 2.5 to 3.0, for instance, 2.75, is set as the threshold value so as to divide the reflectance ratio into a region of 2.75 or more and a region of less than 2.75. Thus it is possible to easily distinguish the vegetations that are in the former region from the other subjects that are in the latter region, except noise. Note that the allowable range of error by noise is 0.25/2.75 (approximately 9.1%).

In addition, when the weather can be determine (raining or not) by a rainfall sensor and the like, the threshold value is set at a value between 2.0 to 3.0, for instance, 2.5, in no rain condition so as to divide the reflectance ratio into a region of 2.5 or more and a region of less than 2.5. Thus it is possible to easily distinguish the vegetations that are in the former region from the other subjects that are in the latter region, except noise. The allowable range of error by noise is 0.5/2.5 (approximately 20%). Moreover, the threshold value is defined by the value between 2.5 to 4.0, for instance, 3.25, in rainy condition so as to divide the reflectance ratio into a region of 3.25 or more and a region of less than 3.25. Thus, it is possible to easily distinguish the vegetations that are in the former region from the other subjects that are in the latter region, except noise. The allowable range of error by noise is 0.75/3.25 (approximately 23%). Therefore, the more stable detector can be obtained.

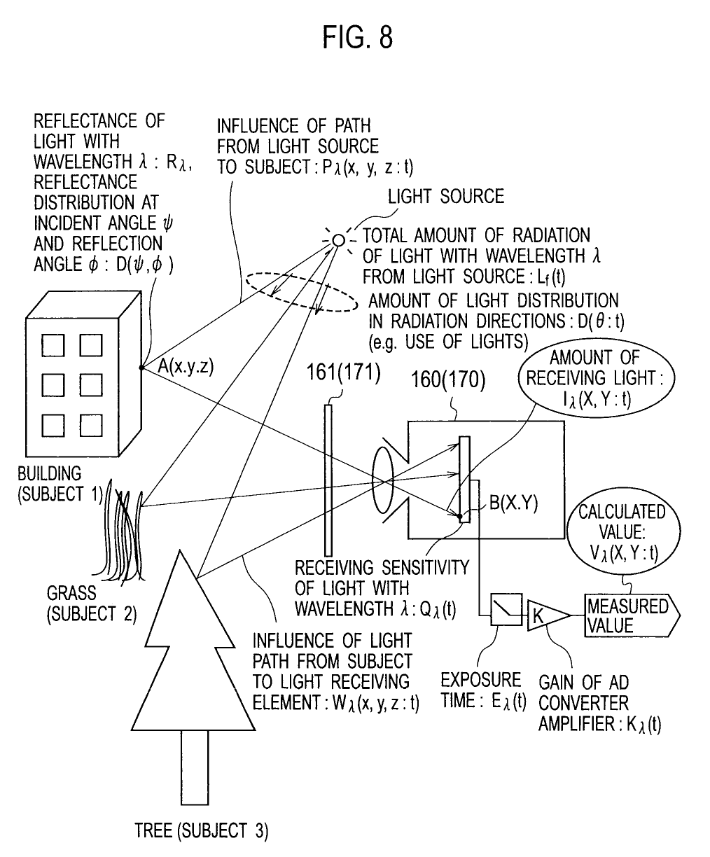

There will be described below in detail a calculating method of the ratio (reflectance ratio) of the reflectance of the near infrared light and the reflectance of the water absorption wavelength band light in observation points of subjects with reference to FIG. 8. In FIG. 8 light from the light source was applied to the subjects such as buildings (subject 1), grass (subject 2) and trees (subject 3), and cameras 160 and 170 that transmitted light, in particular, the near infrared light and the water absorption wavelength band light of the reflected light from the subjects, respectively, are used so as to prepare a situation to take images of each subject. The camera 160 is a near infrared light camera including a near infrared light transmission filter 161 to receive the near infrared light (in a case that wavelength λ in the figure is the near infrared light wavelength band) from each observation point (x, y, z) of each subject. The camera 170 is a water absorption wavelength band light camera including a water absorption wavelength band light transmission filter 171 to receive the water absorption wavelength band light (in a case that wavelength λ in the figure is the water absorption wavelength band) from each observation point (x, y, z) of each subject.

The amount of received light per hour at the time of t in each pixel (coordinate (X, Y) on the light receiving surface) of the near infrared light camera 160 can be calculated by

$$\begin{matrix}\begin{matrix}{I}_{N I R} ( X , Y \text{:} t ) = \frac{{V}_{N I R} ( X , Y \text{:} t )}{{E}_{N I R} ( t ) \cdot {K}_{N I R} ( t )} \\ = {Q}_{N I R} ( t ) \cdot {L}_{N I R} ( t ) \cdot {P}_{N I R} ( x , y , z \text{:} t ) \cdot \\ {R}_{N I R} ( x , y , z \text{:} t ) \cdot D ( ψ , ϕ \text{:} t ) \cdot {W}_{N I R} ( x , y , z \text{:} t )\end{matrix} & ( 21 )\end{matrix}$$

based on formula (17). Similarly, the amount of received light per hour at the time of t in each pixel (coordinate (X, Y) on the light receiving surface) of the water absorption wavelength band light camera 170 can be calculated by

$$\begin{matrix}\begin{matrix}{I}_{S W I R} ( X , Y \text{:} t ) = \frac{{V}_{S W I R} ( X , Y \text{:} t )}{{E}_{S W I R} ( t ) \cdot {K}_{S W I R} ( t )} \\ = {Q}_{S W I R} ( t ) \cdot {L}_{S W I R} ( t ) \cdot {P}_{S W I R} ( x , y , z \text{:} t ) \cdot \\ {R}_{S W I R} ( x , y , z \text{:} t ) \cdot D ( ψ , ϕ \text{:} t ) \cdot {W}_{S W I R} ( x , y , z \text{:} t )\end{matrix} & ( 22 )\end{matrix}$$

based on formula (18). Here I_{NIR}(X_{NIR}, Y_{NIR}:t) and I_{SWIR}(X_{SWIR}, Y_{SWIR}:t) represent the amount of received light amount per hour at a time t in coordinate (X, Y) on the light receiving surfaces of the near infrared light camera and the water absorption wavelength band light camera, respectively; V_{NIR}(X_{NIR}, Y_{NIR}:t) and V_{SWIR}(X_{SWIR}, Y_{SWIR}:t) represent an pixel value at a time t in coordinate (X, Y) on the light receiving surfaces of the near infrared light camera and the water absorption wavelength band light camera, respectively; E_{NIR}(t) and E_{SWIR}(t) represent exposure time at a time t, respectively; K_{NIR}(t) and K_{SWIR}(t) represent imaging gain at a time t, respectively; L_{NIR}(t) and L_{SWIR}(t) represent the light amount of the near infrared light and the water absorption wavelength band light of light from a light source at a time t, respectively; R_{NIR}(x, y, z:t) and R_{SWIR}(x, y, z:t) represent the reflectance of the near infrared light and the water absorption wavelength band light of the reflected light from a subject at a time t, respectively; D(ψ,φ:t) represents the reflectance distribution of the reflected light (the near infrared light and the water absorption wavelength band light) from the subject in which an incident angle ψ from the light source to each observation point of the subject and a reflection angle φ from each observation point to the light receiving surfaces of the near infrared light and the water absorption wavelength band light are parameters; P_{NIR}(x, y, z:t) and P_{SWIR}(x, y, z:t) represent the transmission of the near infrared light and the water absorption wavelength band light on light paths from the light source to the subject at a time t, respectively; W_{NIR}(x, y, z:t) and W_{SWIR}(x, y, z:t) represent the transmission of the near infrared light and the water absorption wavelength band light on light paths from the subject to the light receiving surfaces of the near infrared light and the water absorption wavelength band light at a time t, respectively (this is the F value of the lens because of a short range in the atmosphere); and Q_{NIR}(t) and Q_{SWIR}(t) represent the transfer efficiency (which is the product of light receiving areas and transfer efficiency) in the light receiving surfaces of the near infrared light and the water absorption wavelength band light, respectively. The above-mentioned amounts can be obtained by the pixel values observed by each camera in real time.

For instance, suppose that the reflectances R^{Ref}_{NIR}(x, y, z:t₀) and R^{Ref}_{SWIR}(x, y, z:t₀) of the near infrared light and the water absorption wavelength band light for the subject for calibration at calibration is observed at calibration (t=t₀). In this case, formula (21) leads to

$$\frac{{I}_{N I R} ( X , Y \text{:} t )}{{I}_{N I R} ( X , Y \text{:} {t}_{0} )} = \frac{\begin{matrix}{Q}_{N I R} ( t ) \cdot {L}_{N I R} ( t ) \cdot {P}_{N I R} ( x , y , z \text{:} t ) \cdot \\ {R}_{N I R} ( x , y , z \text{:} t ) \cdot D ( ψ , ϕ \text{:} t ) \cdot {W}_{N I R} ( x , y , z \text{:} t )\end{matrix}}{\begin{matrix}{Q}_{N I R} ( {t}_{0} ) \cdot {L}_{N I R} ( {t}_{0} ) \cdot {P}_{N I R} ( x , y , z \text{:} {t}_{0} ) \cdot \\ {R}_{N I R}^{Ref} ( x , y , z \text{:} {t}_{0} ) \cdot {W}_{N I R} ( x , y , z \text{:} {t}_{0} )\end{matrix}} \qquad ( 23 )$$

and also formula (22) leads to

$$\frac{{I}_{S W I R} ( X , Y \text{:} t )}{{I}_{S W I R} ( X , Y \text{:} {t}_{0} )} = \frac{\begin{matrix}{Q}_{S W I R} ( t ) \cdot {L}_{S W I R} ( t ) \cdot {P}_{S W I R} ( x , y , z \text{:} t ) \cdot \\ {R}_{S W I R} ( x , y , z \text{:} t ) \cdot D ( ψ , ϕ \text{:} t ) \cdot {W}_{S W I R} ( x , y , z \text{:} t )\end{matrix}}{\begin{matrix}{Q}_{S W I R} ( {t}_{0} ) \cdot {L}_{S W I R} ( {t}_{0} ) \cdot {P}_{S W I R} ( x , y , z \text{:} {t}_{0} ) \cdot \\ {R}_{S W I R}^{Ref} ( x , y , z \text{:} {t}_{0} ) \cdot {W}_{S W I R} ( x , y , z \text{:} {t}_{0} )\end{matrix}} . \qquad ( 24 )$$

If the heat transfer efficiencies Q_{NIR}(t) and Q_{SWIR}(t) can be approximated by fixed values (i.e. Q_{NIR}(t)=Q_{NIR}(t₀)=Q_{NIR} and Q_{SWIR}(t)=Q_{SWIR}(t₀)=Q_{SWIR}), respectively, since the efficiencies do not vary with time, the transmission of the near infrared light and the water absorption wavelength band light W_{NIR}(x, y, z:t) and W_{SWIR}(x, y, z:t) can be approximated by fixed values (i.e. W_{NIR}(x, y, z:t)=W_{NIR}(x, y, z:t₀)=W_{NIR} and W_{SWIR}(x, y, z:t)=W_{SWIR}(x, y, z:t₀)=W_{SWIR}), respectively, and the fluctuation of the light amounts L_{NIR}(t) and L_{SWIR}(t) is small (i.e. L_{NIR}(t)=L_{NIR}(t₀) and L_{SWIR}(t)=L_{SWIR}(t₀)), Then formulas (23) and (24) are modified as

$$\begin{matrix}\frac{{I}_{N I R} ( X , Y \text{:} t )}{{I}_{N I R} ( X , Y \text{:} {t}_{0} )} = \frac{{P}_{N I R} ( x , y , z \text{:} t ) \cdot {R}_{N I R} ( x , y , z \text{:} t ) \cdot D ( ψ , ϕ \text{:} t )}{{P}_{N I R} ( x , y , z \text{:} {t}_{0} ) \cdot {R}_{N I R}^{Ref} ( x , y , z \text{:} {t}_{0} )} \\ and & ( 25 ) \\ \frac{{I}_{S W I R} ( X , Y \text{:} t )}{{I}_{S W I R} ( X , Y \text{:} {t}_{0} )} = \frac{{P}_{S W I R} ( x , y , z \text{:} t ) \cdot {R}_{S W I R} ( x , y , z \text{:} t ) \cdot D ( ψ , ϕ \text{:} t )}{{P}_{S W I R} ( x , y , z \text{:} {t}_{0} ) \cdot {R}_{S W I R}^{Ref} ( x , y , z \text{:} {t}_{0} )} , & ( 26 )\end{matrix}$$

respectively.

Then, dividing formula (25) by formula (26) gives

$$\frac{{I}_{N I R} ( X , Y \text{:} t ) / {I}_{N I R} ( X , Y \text{:} {t}_{0} )}{{I}_{S W I R} ( X , Y \text{:} t ) / {I}_{S W I R} ( X , Y \text{:} {t}_{0} )} = \frac{{R}_{N I R} ( x , y , z \text{:} t )}{{R}_{S W I R} ( x , y , z \text{:} t )} \cdot \frac{{P}_{N I R} ( x , y , z \text{:} t )}{{P}_{S W I R} ( x , y , z \text{:} t )} \cdot \frac{{P}_{S W I R} ( x , y , z \text{:} {t}_{0} )}{{P}_{N I R} ( x , y , z \text{:} {t}_{0} )} \cdot \frac{{R}_{S W I R}^{Ref} ( x , y , z \text{:} {t}_{0} )}{{R}_{N I R}^{Ref} ( x , y , z \text{:} {t}_{0} )} . \qquad ( 27 )$$

When the light source such as a searchlight is used, the reflectance of light from the light source in a subject depends on the incident angle from a light source to the subject. While, the light amount loss on a light path of the reflected light can be ignored. Therefore the change of the light amount on the light path until the light applied from the light source is arrived in the light receiving surfaces of the cameras by reflecting at the subject depends only on the incident angle from the light source to the subject, not depending on the light wavelength. This means that

P_{NIR}(x, y, z:t)=P_{SWIR}(x, y, z:t), P_{NIR}(x, y, z:t₀)=P_{SWIR}(x, y, z:t₀). (28)

Substituting condition (28) into formula (27) gives

$$\frac{{I}_{N I R} ( X , Y \text{:} t ) / {I}_{N I R} ( X , Y \text{:} {t}_{0} )}{{I}_{S W I R} ( X , Y \text{:} t ) / {I}_{S W I R} ( X , Y \text{:} {t}_{0} )} = \frac{{R}_{N I R} ( x , y , z \text{:} t )}{{R}_{S W I R} ( x , y , z \text{:} t )} \cdot \frac{{R}_{S W I R}^{Ref} ( x , y , z \text{:} {t}_{0} )}{{R}_{N I R}^{Ref} ( x , y , z \text{:} {t}_{0} )} , \\ namely , \\ \begin{matrix}\frac{{R}_{N I R} ( x , y , z \text{:} t )}{{R}_{S W I R} ( x , y , z \text{:} t )} = \frac{{R}_{N I R}^{Ref} ( x , y , z \text{:} {t}_{0} )}{{R}_{S W I R}^{Ref} ( x , y , z \text{:} {t}_{0} )} \cdot \frac{{I}_{N I R} ( X , Y \text{:} t ) / {I}_{N I R} ( X , Y \text{:} {t}_{0} )}{{I}_{S W I R} ( X , Y \text{:} t ) / {I}_{S W I R} ( X , Y \text{:} {t}_{0} )} \\ = \frac{{I}_{N I R} ( X , Y \text{:} t )}{{I}_{S W I R} ( X , Y \text{:} t )} \cdot \\ \{ \frac{{R}_{N I R}^{Ref} ( x , y , z \text{:} {t}_{0} )}{{R}_{S W I R}^{Ref} ( x , y , z \text{:} {t}_{0} )} \cdot \frac{{I}_{S W I R} ( X , Y \text{:} {t}_{0} )}{{I}_{N I R} ( X , Y \text{:} {t}_{0} )} \} .\end{matrix} \qquad ( 29 )$$

While, when the light source such as the sun is used, condition (28) cannot be used in general since light from the light source is affected by atmospheric influence such as scattering. In that case, it is assumed the condition

P_{NIR}(x, y, z:t)=P_{NIR}(x, y, z:t₀), P_{SWIR}(x, y, z:t)=P_{SWIR}(x, y, z:t₀). (30)

This condition is effective during no large shift of the sun inclination that is a major factor of the sun light scattering. Similarly, formula (29) can be obtained by substituting condition (30) into formula (27).

Thus, even when the light source is the searchlight, or the sun under the condition that the position is changed little even after calibration, formula (29) is equally obtained.

Moreover, formula (29) can be modified as

$$\begin{matrix}\begin{matrix}\frac{{R}_{N I R} ( x , y , z \text{:} t )}{{R}_{S W I R} ( x , y , z \text{:} t )} = \frac{{I}_{N I R} ( X , Y \text{:} t )}{{I}_{S W I R} ( X , Y \text{:} t )} \cdot \\ \{ \frac{{R}_{N I R}^{Ref} ( x , y , z \text{:} {t}_{0} )}{{R}_{S W I R}^{Ref} ( x , y , z \text{:} {t}_{0} )} \cdot \frac{{I}_{S W I R} ( X , Y \text{:} {t}_{0} )}{{I}_{N I R} ( X , Y \text{:} {t}_{0} )} \} \\ = \frac{{I}_{N I R} ( X , Y \text{:} t )}{{I}_{S W I R} ( X , Y \text{:} t )} \times {C}_{Ref}\end{matrix} & ( 31 )\end{matrix}$$

by use of formula (20).

Consequently, the ratio (reflectance ratio) Rate_{Ref}(x, y, z:t) of the reflectance R_{NIR}(x, y, z:t) of the near infrared light to the reflectance R_{SWIR}(x, y, z:t) of the water absorption wavelength band light in an observation point of the subject (x, y, z) at a time t can be calculated as

$$\begin{matrix}\begin{matrix}{Rate}_{Ref} ( x , y , z \text{:} t ) = \frac{{R}_{N I R} ( x , y , z \text{:} t )}{{R}_{S W I R} ( x , y , z \text{:} t )} \\ = {C}_{Ref} \times \frac{{I}_{N I R} ( X , Y \text{:} t )}{{I}_{S W I R} ( X , Y \text{:} t )} \\ = {C}_{Ref} \times \\ \frac{{V}_{N I R} ( X , Y \text{:} t ) / ( {E}_{N I R} ( t ) \cdot {K}_{N I R} ( t ) )}{{V}_{S W I R} ( X , Y \text{:} t ) / ( {E}_{S W I R} ( t ) \cdot {K}_{S W I R} ( t ) )}\end{matrix} & ( 32 )\end{matrix}$$

by use of formulas (21) and (22) similar to formula (19).

The vegetation detection may be performed by use of a function of the reflectance ratio Rate_{Ref}(x, y, z:t) such as

$$F ( {Rate}_{Ref} ( x , y , z \text{:} t ) ) = \frac{{Rate}_{Ref} ( x , y , z \text{:} t ) - 1}{{Rate}_{Ref} ( x , y , z \text{:} t ) + 1} \qquad ( 33 )$$

with simpler values (in this case, between 0 to 1) in place of the reflectance ratio Rate_{Ref}(x, y, z:t) itself

As shown in FIGS. 2 and 3, since the vegetations and the other subjects are clearly different in the reflectance ratio of the near infrared light to the water absorption wavelength band light, the vegetation detection is performed taking advantage of this property.

With regard to the above-mentioned vegetation detection using the reflectance ratio of the near infrared light to the water absorption wavelength band light, it is emphasized that this is a new combination for vegetation detection provided as a result of testing a variety of combinations. As for the other possibilities, at least the following options may be considered, but they have disadvantages.

(A) It is known that the reflectance ratio of infrared light to ultraviolet light alters according to the composition roughness of a substance. Therefore, since the reflectance of vegetations differs from the reflectance of other substances that have density and roughness different from those of plant cells, a vegetation detecting method of using the reflectance ration may be possible.

Although a difference of the reflectance ratio is recognized regarding sand and soil, there are substances undetectable by the reflectance ratio regarding plastics regardless of color. A possible reason is that ultraviolet adsorbent for preventing deterioration of plastics is included therein.

(B) It may be also possible to consider the reflectance (or absorbance) of blue light (400 nm to 500 nm) and red light as the reflectance (or absorbance) of chlorophyll and carotene, respectively, so as to detect vegetations, as another proposal.

Although differing in color to be error detection, this method faultily detects plastics colored with dyes as well as the method described in Patent Citation 2.

On the other hand, the present invention adopts a method of detecting vegetations by use of the small reflectance of the water absorption wavelength band light in the short wave infrared light, and the large reflectance of the near infrared light.

At the beginning, it was considered that there was a possibility of not being able to distinguish vegetations from wet earth and sand by this method. However, it has been recognized by tests that there is a great difference in the absorbance of vegetations and that of wet earth and sand. A possible reason is that wet earth and sand absorb only the water on these surfaces since light is mainly reflected on these surfaces. However, the vegetations greatly absorb the light since light is repeatedly reflected diffusely in the cells thereof. Moreover, the attenuation of light similar to the case that light passes through water with several mm order has been observed in the tests, which is a basis for this method.

### MODIFIED EXAMPLE

The water absorption wavelength includes a wavelength band centered on 1940 nm, which is effective to use. From the data of the broadleaf tree shown in FIG. 7, it is recognized that the water absorption is large within the range of 1900 nm to 2100 nm and the water absorption is small in 1850 nm or less or 2150 nm or more. Thus, when a wavelength band centered on 1940 nm is used, it is preferably used a band pass filter of which the transmission width is 50 nm or more, the lower limit of the transmission wavelength is more than 1850 nm, and the upper limit of the transmission wavelength is less than 2150 nm.

As described above, according to the vegetation detector of the present invention, it is possible to (1) prevent discrimination errors between vegetations and other subjects even in a situation where bright spots and dark spots are present, such as in a section with sunlight filtering through trees, (2) prevent constructions constructed of blue-colored plastics from accidentally being detected as vegetations, and (3) operate detection of vegetations at night without a floodlight using a light source of strong visible light such as a searchlight.

The invention is not limited to the embodiment described above and modifications may become apparent to these skilled in the art, in light of the teachings herein.

This application is based upon the Japanese Patent Application No. 2008-135713, filed on May 23, 2008, the entire content of which is incorporated by reference herein.

1. A vegetation detector comprising:
a first imaging section that includes a first optical filter selectively transmitting light with a near infrared wavelength band;
a second imaging section that includes a second optical filter selectively transmitting light with a water absorption wavelength band in a short wave infrared wavelength band;
a reflectance ratio calculating section that calculates a ratio of a reflectance calculated based on observation data of light from subjects obtained by the first imaging section to a reflectance calculated based on observation data of light from the subjects obtained by the second imaging section as a reflectance ratio; and
a determining section that determines whether the subjects are vegetations or not by comparing the reflectance ratio with a predetermined threshold value.

2. (canceled)

3. The vegetation detector according to claim 1,
wherein the first optical filter selectively transmits near infrared light of which a transmission width is 100 nm or more in a wavelength band of 800 nm to 1300 nm, and the second optical filter selectively transmits short wave infrared light of which a transmission width is 50 nm or more in a wavelength band of 1350 nm to 1550 nm or 1850 nm to 2150 nm.

4. A method of detecting vegetation comprising:
calculating a ratio of a reflectance calculated based on observation data of light from subjects obtained by a first imaging section including a first optical filter selectively transmitting light with a near infrared wavelength band to a reflectance calculated based on observation data of light from the subjects obtained by a second imaging section including a second optical filter selectively transmitting light with a water absorption wavelength band in a short wave infrared wavelength band; and
determining whether the subjects are vegetations or not by comparing the reflectance ratio with a predetermined threshold value.

5. (canceled)

6. The method of detecting vegetation according to claim 4,
wherein the first optical filter selectively transmits near infrared light of which a transmission width is 100 nm or more in a wavelength band of 800 nm to 1300 nm, and the second optical filter selectively transmits light of which a transmission width is 50 nm or more in a wavelength band of 1350 nm to 1550 nm or 1850 nm to 2150 nm.
